(19) United States
(12) Patent Application Publication
(10) Pub. No.: US 2018/0246056 A1
(43) Pub. Date: Aug. 30, 2018

(54) PULSE-FIELD MULTIPLEX CAPILLARY ELECTROPHORESIS SYSTEM

(71) Applicant: Advanced Analytical Technologies, Inc., Ankeny, IA (US)

(72) Inventors: Bruce R. Boeke, Ames, IA (US); Martin Chris Foster, Nevada, IA (US); Thomas J. Kurt, Ames, IA (US); Scott Stueckradt, Huxley, IA (US)

(21) Appl. No.: 15/969,014

(22) Filed: May 2, 2018

Related U.S. Application Data
(63) Continuation of application No. 14/984,039, filed on Dec. 30, 2015.
Application No. 14/984,039 is a continuation-in-part of application No. 14/822,956, filed on Aug. 11, 2015.
Application No. 14/822,956 is a continuation of application No. 13/470,870, filed on May 14, 2012, now Pat. No. 9,140,666.
Application No. 13/470,870 is a continuation-in-part of application No. 29/421,549, filed on Mar. 15, 2012, now Pat. No. D689621.
(60) Provisional application No. 61/643,411, filed on May 7, 2012.

(51) Int. Cl. G01N 27/447

(52) U.S. Cl. CPC G01N 27/44782; G01N 27/44791; G01N 27/44743; G01N 27/44713; G01N 27/44704

(57) ABSTRACT

The invention is a multiplex, pulsed-field capillary electrophoresis instrument with the ability to analyze DNA fragments with sizes greater than 50,000 bp, greater than 100,000 bp and even granter than 150,000 base pairs. The parallel capillary electrophoresis system allows for the simultaneous analysis of at least 12 samples while applying a pulse or varying electric field for separation.

### CROSS-REFERENCE TO RELATED APPLICATIONS

This application is a continuation of U.S. Ser. No. 14/984,039, filed Dec. 30, 2015, which is a continuation-in-part and claims the benefit of the filing date of earlier filed, commonly owned, co-pending application Ser. No. 14/822,956, filed Aug. 11, 2015, which itself is a continuation of U.S. Ser. No. 13/470,870, filed May 14, 2012, now U.S. Pat. No. 9,140,666, issued Sep. 22, 2015, which claims the benefit of provisional application 61/643,411, filed May 7, 2012, which is a continuation in part of design application 29/421,549, filed Mar. 15, 2012, now design patent D689, 621, issued Sep. 10, 2013.

### FIELD OF THE INVENTION

This invention relates to a system and software for multi-channel pulsed-field capillary electrophoresis.

### DESCRIPTION OF RELATED ART

The current next-generation sequencing (NGS) platforms use a variety of technologies for sequencing, including pyrosequencing, ion-sequencing, sequencing by synthesis, or sequencing by ligation. Although these technologies have some minor variations, they all have a generally common DNA library preparation procedure, which includes genomic DNA quality & quality assessment, DNA fragmentation and sizing (involving mechanical shearing, sonication, nebulization, or enzyme digestion), DNA repair and end polishing, and a last step of platform-specific adaptor ligation. With a rapidly growing demand for DNA sequence information, there is a critical need to reduce the time required for the preparation of DNA libraries. Many commercial NGS systems are based on the sequencing of relatively short fragments of poly (nucleic acids), ranging from 30 base-pairs (bp) to 2000 bp in length. NGS systems based on pore or nanopore platforms use larger fragment sizes, ranging from 5000 bp or higher. In some cases, the desired fragment sizes are greater than 20,000 to 50,000 bp. Newer applications of long-range sequencers target fragment sizes of 50,000 bp to greater 150,000 bp or longer.

A labor-intensive step in DNA library preparation is the qualification (size determination) and quantification of both un-sheared genomic DNA and downstream fragmented DNA. Existing methods for DNA fragment analysis include agarose gel electrophoresis, capillary electrophoresis, and chip-based electrophoresis. Agarose gel electrophoresis is labor intensive, requiring gel preparation, sample transfer via pipetting, and image analysis. The images obtained by agarose electrophoresis are often distorted, resulting in questionable or unreliable data. It is impossible to use agarose gel electrophoresis for accurate quantification of DNA, which means that a separate, second method (UV or fluorescence spectroscopy) is required for quantification. Finally, agarose gel electrophoresis is difficult to automate. Chip or micro-chip based electrophoresis provides an improvement in data quality over agarose gel electrophoresis but is still labor intensive. For example, chip-based methods require manual steps to load gel, markers and samples. Even though these microchip or chip based electrophoresis units can run a single sample in seconds or minutes, the sample and gel loading are barriers to ease-of-use, especially when running hundreds or thousands of samples. Also, existing chip-based systems are unable to quantify genomic DNA. Capillary electrophoresis (CE) offers advantages over both agarose electrophoresis and microchip electrophoresis in that gel-fill and sample loading is automated.

Standard constant electric field microchip and capillary electrophoresis systems currently available will typically report DNA size values of no greater than 50,000 bp, even though the DNA fragments may actually be much larger. Thus, standard microchip and capillary electrophoresis systems are limited in their ability to accurately measure DNA fragment sizes above about 50,000 bp. Newer sequencing technology requires analysis of input DNA with sizes greater than about 50,000 bp.

The standard method for the analysis of large fragments of DNA is Slab-Gel Pulsed-Field Gel Electrophoresis (PFGE) where DNA with size ranges from less than 1000 base pair (bp) to several million bp can be separated and accurately sized. A major limitation in PFGE is sample throughput, because the time required for analysis can range from several hours to several days, depending on the size range of interest and the complexity of sample preparation.

The technology of alternating, pulsed fields has been extended from PFGE to single-capillary electrophoresis, with the goal of decreasing analysis time of large DNA fragment from the hours/days of PFGE to less than two hours. For example, Karger in U.S. Pat. No. 5,122,248 describes a single-capillary pulsed field capillary electrophoresis system (PFCE). Magnusdottir et. al. in “Electrohydrodynamically Induced Aggregation During Constant and Pulsed Field capillary Electrophoresis of DNA” (Biopolymers, Vol 49, 385-401, 1999) describe a PFCE system. Although these pulsed-field single capillary electrophoresis systems can accurately measure DNA up to sizes of 200,000 bp, the throughput is limited to one sample per run. Even though the run times of capillary pulse field electrophoresis can be from less than 20 minutes to an hour, sample loads of hundreds of samples may take several hours to days to run.

There is thus a need for pulse-field capillary electrophoresis systems that can run multiple samples simultaneously to allow efficient throughput and measurement of larger fragments.

Multiplex capillary electrophoresis is known. For example Kennedy and Kurt in U.S. Pat. No. 6,833,062 describe a multiplex absorbance based capillary electrophoresis system and method. Yeung et al. in U.S. Pat. No. 5,324,401 describe a multiplex fluorescent based capillary electrophoresis system. Although these systems offer the advantage of analyzing multiple samples simultaneously, and can run several plates sequentially, they lack the ability to load or change multiple sample plates while the system is running, and they also lack a simple workflow for efficient sample analysis. Furthermore, these multiplex systems lack the ability to measure nucleic acid fragment sizes above about 50,000 bp.

A limitation of prior-art pulsed-field capillary electrophoresis systems is the lack of an option for environmental temperature control. Temperature can affect run-to-run performance and the long-term reliability of capillary pulse-field systems. Thus, there is a need for a multiplex pulsed-field capillary electrophoresis systems that have an option for carefully controlled environmental temperature control.

While existing commercial CE systems can be automated with a robotic system, stand-alone systems are not fully automated or lack the sensitivity and data quality required for adequate DNA library analysis. An example of a CE instrument with a robot-capable interface is given by Kurt et al. in U.S. Pat. No. 7,118,659. For the construction of DNA libraries, as well as other applications such as mutation detection, it is often necessary to run thousands of samples per day, but the implementation of a robotic system for sample handling is prohibitively expensive, and many labs lack the expertise necessary for the maintenance and operation of sophisticated robotic systems. Automated forms of micro-slab-gel electrophoresis have been developed, such as those described in United States Patent Application number 20100126857. These allow for automatic analysis of multiple samples, but the techniques either still require significant human intervention, or they do not have the throughput required for high-volume applications. Amirkhanian et al. in U.S. Pat. No. 6,828,567 describe a 12-channel multiplex capillary electrophoresis system capable of measuring up 12 samples at a time using multiplex capillary electrophoresis. However, this system is not capable of measuring multiple 96-well plates, and does not have the workflow that allows the analysis of thousands of samples per day.

As can be seen, there is a continuing need for an automated capillary electrophoresis system that a) eliminates the complexity, cost, and required expertise of a robotic system b) enables users to run from one to several thousand samples per day and c) allows users to conveniently load several plates or samples onto a capillary electrophoresis system while the system is running other samples d) has the small size and footprint of a stand-alone capillary electrophoresis unit and e) allows users to accurately determine the size of DNA fragments larger than 50,000 bp, and preferably larger than 100,000 bp.

This invention has as a primary objective the fulfillment of the above described needs.

### BRIEF SUMMARY OF THE INVENTION

The present invention is a pulse-field multiplex capillary electrophoresis system and console with an improved sample handling and control method for the analysis of samples.

One embodiment of the invention is a pulse-field capillary electrophoresis system with the ability of apply a varying or pulsed electric field to at least 2 and preferably at least 12 capillaries simultaneously.

Another embodiment of the invention is a multiplex capillary electrophoresis system that is capable of accurately measuring the size of DNA fragments greater than 50,000 bp and preferably greater than 100,000 bp up to 150,000 bp or larger.

Another embodiment of the invention is use of pulsed field with a console with a series of at least four and preferably at least six vertically stacked user-accessible drawers that can each hold a plate containing from 1 to 384 sample wells. Preferably, each user accessible drawer holds a sample plate containing 96 sample wells. The system is configured so that sample plates can be loaded onto the system at any time, including during the electrophoresis or analysis of samples. User “A” can walk up to the machine, load a row of 12 samples, enter loading and analysis instructions onto the computer and walk away. While user “A” samples are running, user “B” can walk up to the machine, load a tray of 96 samples, enter loading and analysis instructions and walk away. User “C” can walk up to the machine, load 12 samples, while either user “A” or user “B” samples are running, enter loading and analysis instructions, and walk away. Two of the preferred six user-accessible drawers are used to hold an electrophoresis run buffer and a waste tray.

Another embodiment of the invention is a mechanical stage that transports sample trays and/or buffer or waste trays from any one of the vertically stacked user-accessible drawers to the injection electrodes and capillary tips of the multiplex capillary array of the capillary electrophoresis subsystem.

Another embodiment of the invention uses a computer program that enables a user to create a queue of jobs, with each job representing an analysis of a new set of samples. This computer system enables users to enter job data even when the system is running samples. For example, user “A” loads “sample plate 1” into the system into Drawer 3 and uses a computer program to add a job to a queue, the job representing the injection and capillary electrophoresis of samples in “sample plate 1” in Drawer 3. While the system is running user A's samples, user B loads plate 2 into Drawer 4 and uses the same computer program to add a job to a queue, the job representing the injection and capillary electrophoresis of samples in “sample plate 2” in Drawer 4. User C loads “sample plate 3” into Drawer 5 and uses the same computer program to add a job to the queue, the job representing the injection and capillary electrophoresis of samples in “sample plate 3” in Drawer 5.

A preferred embodiment of this invention is a system capable of allowing the user to enter 24 or more individual jobs to a queue, with each job representing an injection and analysis of a plurality of samples.

An even more preferred embodiment is a system capable of allowing the user to enter 48 or more individual jobs to a queue, with each job representing an injection and analysis of a plurality of samples.

Another embodiment is a system capable of allowing the user to enter 100 or more individual jobs to a queue, with each job representing an injection and analysis of a plurality of samples.

### BRIEF SUMMARY OF THE DRAWINGS

FIG. 1 shows a left-front-view of the instrument, with 6 drawers for holding sample and buffer plates.

FIG. 2 shows a right-front view of the instrument with one drawer pulled out for placement of a buffer plate and the top and side door compartments open.

FIG. 3 shows the x-z stage assembly.

FIG. 4 shows a drawer, stage assembly, tray holder, and sample plate.

FIG. 5 shows the bottom of a tray holder.

FIG. 6 shows a right-side view of the instrument without the cover.

FIG. 7 shows the left-side view of the instrument without the cover.

FIG. 8 shows a capillary array cartridge

FIG. 9 shows the flow-chart for the software control program for creating a queue of jobs.

FIG. 10 shows a computer screen image of the computer software.

FIG. 11 shows the positioning of a sample plate under the array by the stage.

FIG. 12A shows a view of the capillary electrophoresis reservoir system.

FIG. 12B shows a view of the capillary electrophoresis reservoir system.

FIG. 13A shows a view of the x-z stage relative to the drawers.

FIG. 13B shows a view of the x-z stage with a sample tray lifted.

FIG. 14 shows a back view of the instrument with a pulse-field power supply.

FIG. 15A shows a top view of the instrument with a temperature control chamber.

FIG. 15B shows a cutout view of the temperature control chamber.

FIG. 16A shows a prior-art slab-gel separation of Marker 7GT

FIG. 16B shows the separation of Marker 7GT using prior-art capillary electrophoresis with constant applied electric field.

FIG. 16C shows the separation of Marker 7GT using the capillary electrophoresis system of the present invention with a pulsed applied electric fiel0d.

FIG. 17 shows a dual LED, dual fiber optic bundle light-guide assembly.

### DETAILED DESCRIPTION OF THE INVENTION

The invention is a multiplexed pulsed-field capillary electrophoresis system with enhanced workflow. The capillary electrophoresis system and apparatus of the present invention includes an absorbance or fluorescence-based capillary electrophoresis sub-system with a light source, a method for carrying light from the light source to the sample windows of a multiplex capillary array containing at least 12 capillaries (preferably 96 capillaries), and a method for detecting light emitted (fluorescence) or absorbed (absorbance) from the sample windows of a multiplex array. The sub-system also includes a method for pumping buffers and gels through the capillaries, as well as a method for application of an electric field for electrophoretic separation. The optics of the fluorescent-based sub system of the present invention are described by Pang in United States Patent Applications 20070131870 and 20100140505, herein incorporated by reference in their entirety. The optics of an applicable absorbance-based system, as well as the fluid handling, reservoir venting, application of electric field, and selection of fluids via a syringe pump and a 6-way distribution valve are discussed by Kennedy et al. in U.S. Pat. Nos. 7,534,335 and 6,833,062, herein incorporated by reference their entirety.

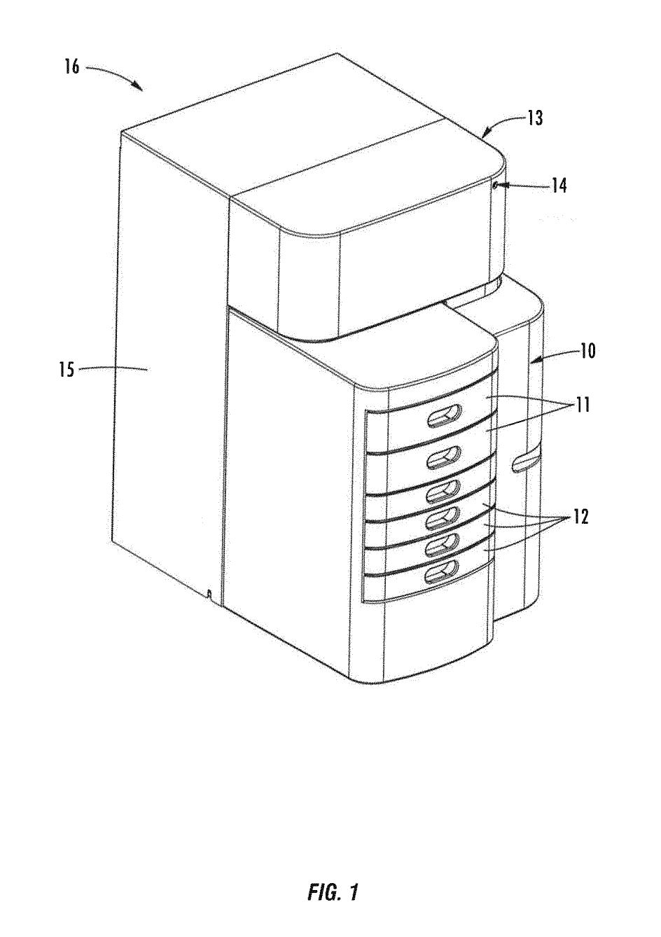

Referring to FIG. 1 the multiplex capillary system and/or console 16, with enhanced workflow has a door 10 for easy access to the loading of gels, two drawers 11 for the easy loading of a buffer tray and a waste tray. Drawers 12 can be opened for easy loading of 96 well PCR plates, tube strips, vials, or other sample containers. A top door 13 can be opened to access a replaceable capillary array, array window, and reservoir. An indicator light 14 is used to for notifying users of the active application of a high-voltage for electrophoresis. A removable back-panel 15 allows access to electronics such as a high-voltage power supply, electrical communication panels, a pump board, pressure transducer board, and stage driver electronics. The back panel 15 also allows maintenance access to the x-z stage, which is used to move sample trays from the drawers 11 and 12 to a capillary array.

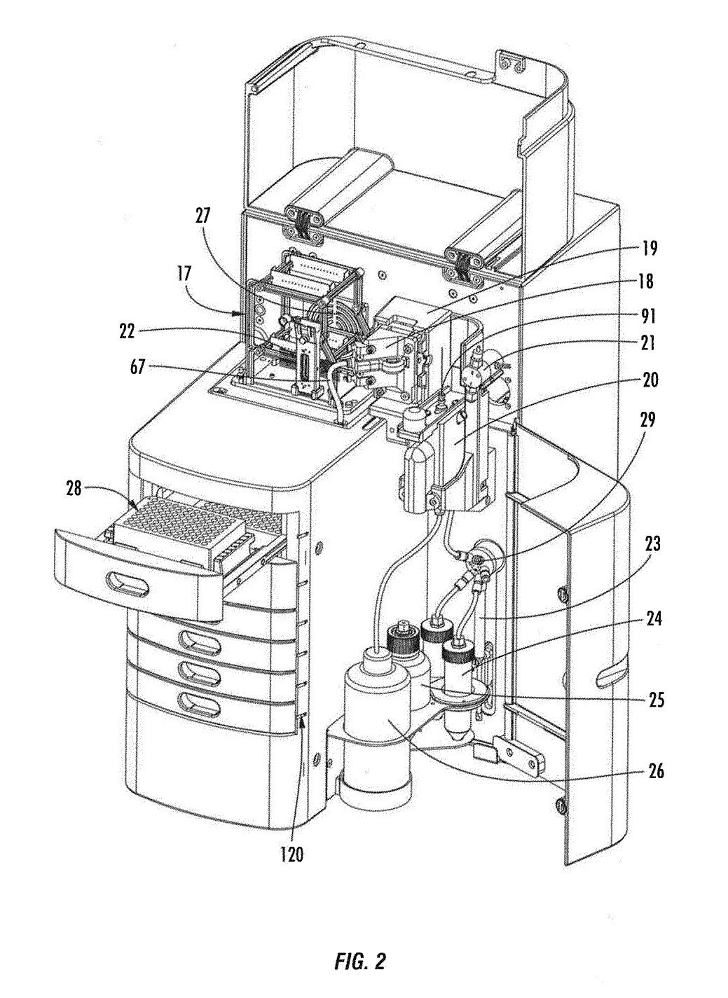

FIG. 2 shows the multiplex capillary system used with the enhanced workflow console 16 with the top and side doors open. A replaceable capillary array 17 holds either 12 or 96 capillaries for multiplex capillary electrophoresis. An LED light guide 67 guides light from a LED engine located in the back compartment to the array window block 22 which is inserted between the array window holder 19 and LED light guide and window holder 18. In this view, array window block 22 is attached to the capillary array 17 for display. When the capillary array is removed, from the system, the array window block 22 can be attached to the capillary array 17 (as shown). When the capillary array is fully installed, the array window block 22 is not visible because it is sandwiched between the array window holder 19 and LED light guide and window holder 18. A vent valve 21 is connected to the top of a capillary reservoir 20. A syringe pump 23 coupled with a 6-way distribution valve 29 delivers fluids and electrophoresis gels from fluid containers 24 and 25 into the capillary reservoir 20, waste container 26, or capillaries in the capillary array 17. A fan 27 is used for forcing cool air from the back compartment through the capillary array 17, past the outside of the reservoir 20, down past the fluid containers 24, 25 and finally out the bottom of the instrument. LED indicator lights 120 are used to indicate the presence or absence of trays in the drawers. A buffer tray 28 is shown in a drawer (11, FIG. 1). The capillary array reservoir tip 91 is shown inserted into the reservoir 20.

The concepts and practical implementation of motion control systems are known. For example, Sabonovic and Ohnishi; “Motion Control” John Wiley and Sons, 2011, herein incorporated by reference in its entirety, discusses practical methods for the design and implementation of motion control. It does not, however, show an enhanced CE workflow console 16 as depicted here.

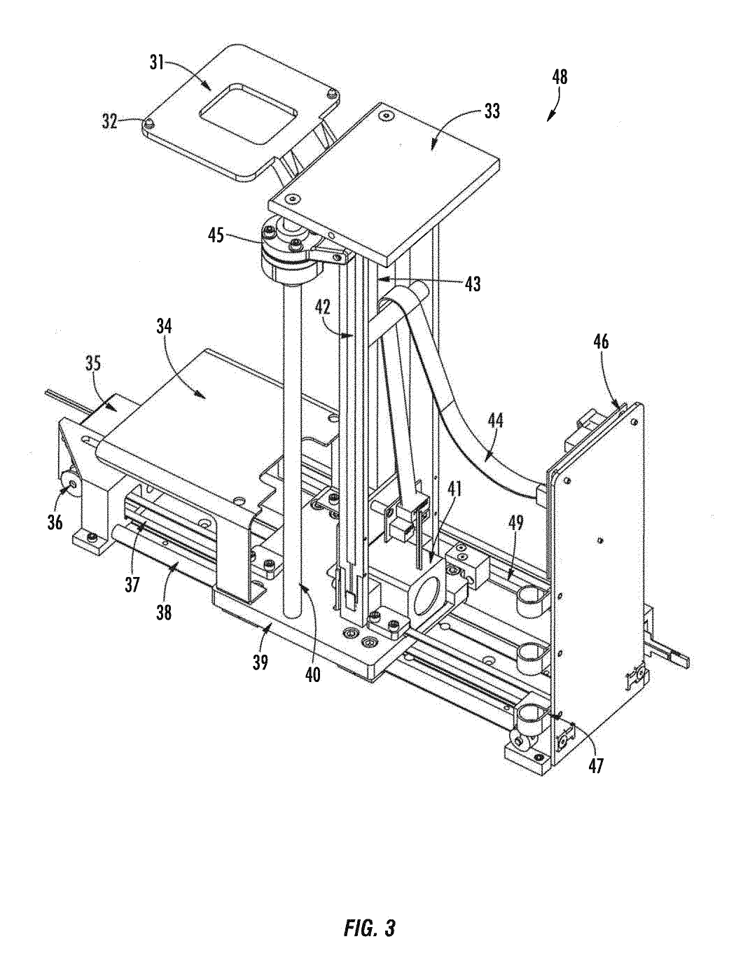

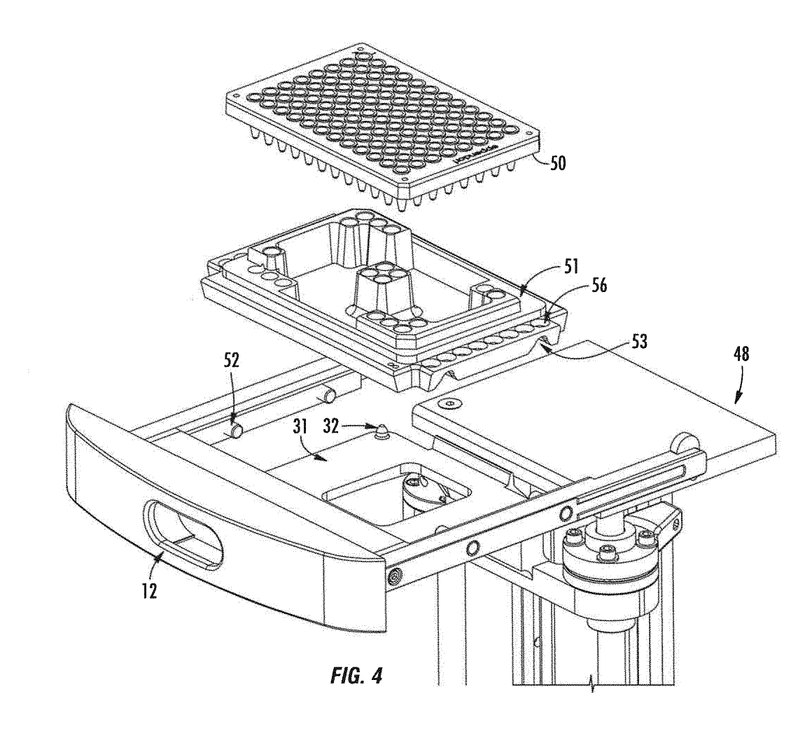

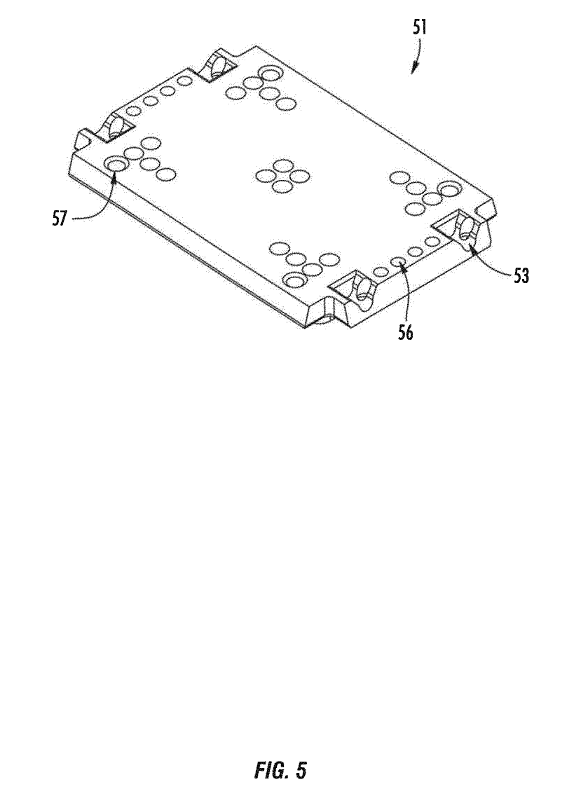

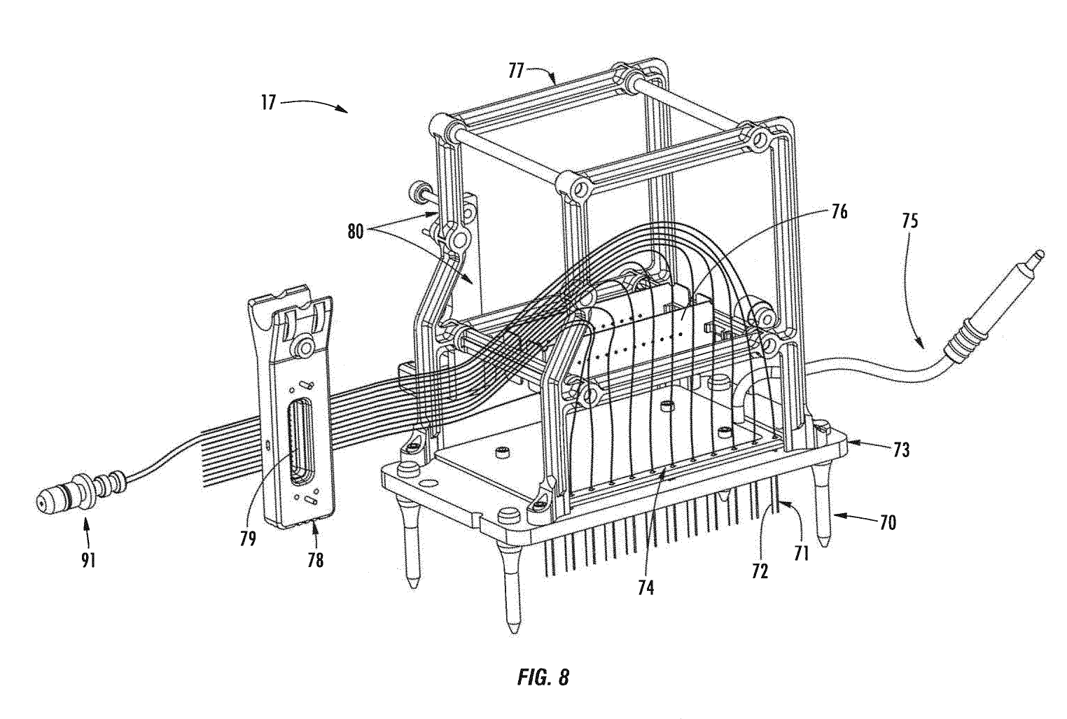

FIG. 3 shows the x-z stage assembly 48, which is used to transport sample trays (50, FIG. 4) and associated tray holders (51, FIG. 4) from the drawers (12 FIG. 1) to the injection capillaries (72, FIG. 8) and injection electrodes (71, FIG. 8) of the capillary array (17, FIG. 8). The x-z stage assembly 48 is also used to position a buffer tray or waste tray (28, FIG. 2) from the drawers (11, FIG. 1) to the injection capillaries and electrodes of the capillary array (72, FIG. 8). The x-z stage assembly has a tray carrier 31 with alignment pins 32, which align with holes (57, FIG. 5) on the bottom of the tray holder (51, FIG. 4) to prevent subsequent sliding or movement of the tray holders during transport. A protective cover 34, made of metal or plastic, is used to prevent gels or other liquids from spilling onto the x-direction guide rails 38 and x-direction drive belt 37 of the stage assembly. An x-drive stepper motor 35 is used as the electro-mechanical driver for motion in the x-direction. A drive pulley 36 is attached to the stepper motor 35 and x-direction drive belt 37 which drives the stage carrier 39 back-and forth along the guide-bars 38. A second drive pulley (not shown) is used on belt 37 towards the back-end of the stage, which allows the belt to make a full loop when affixed to stage carrier 39. Any motor-induced movement of the belt induces an x-direction movement of the stage carrier 39 on the guide rails 38. A stepper-motor for the z-position is located at 41, which is attached to a drive pulley/belt configuration similar to that shown in the x-direction. The x-direction drive belt is shown as 43. The z-position motor/pulley/belt is used to move the tray carrier 31 up and down the guide bars 40. Top plate 33 serves as a structural support for the guide bars 40. An electrical communication strip 44 is used to communicate between an electrical motor control board 46 and the stepper motors 41 and 35. An x-direction membrane potentiometer strip 49, along with appropriate control electronics, is used to determine and control the absolute position of the stage carrier 39 in the x-direction. A z-direction membrane potentiometer strip 42, along with appropriate control electronics, is used to determine the absolute position of the tray carrier 31 in the z-direction. Linear encoders or rotational encoders (on the stepper motor) are alternative forms of positional measurement and control. Bearings 45 are located on each guide bar 40 and guide rail 38 to enable friction-free movement of both the tray carrier 31 and the stage carrier 39. Note that there are two guide bars or guide rails per axis. Electrical cord guide straps 47 are attached to a back support, which also holds the electrical control board 46 for the x-z stage assembly.

FIG. 4 shows a drawer 12, superimposed on an image of the stage assembly 48, tray holder 51, and 96-well sample tray 50. The tray holder 51 is molded to specifically hold a 96-well plate, shown here as 50. Alternative moldings of the tray holder allow for different sample plates, including 384-well plates. Holes (57, FIG. 5) on the bottom of the tray holder 51 align with the alignment pins 32 of the tray carrier (31 FIG. 4). Notches 53 in the tray holder 51 align with alignment pins 52 on the drawer 12 to enable the tray holder to fit in a tight, reproducible way within the sample drawer.

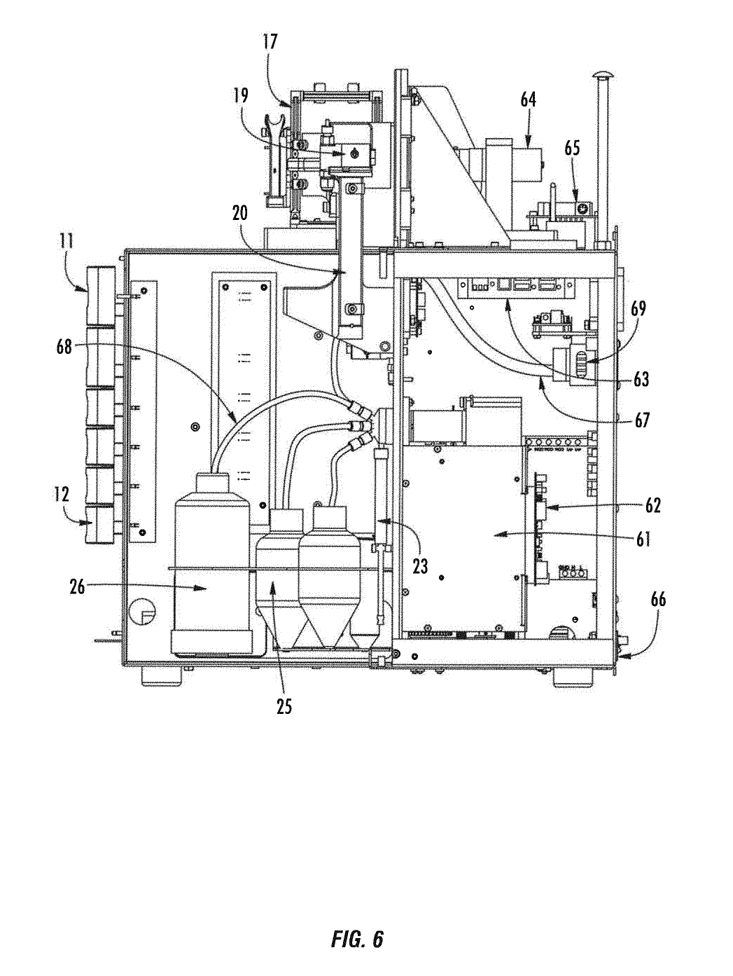

FIG. 6 Shows a right side view of the electrophoresis system, with a chassis 66, pump motor and control system 61, pump control board 62, LED light engine 69, LED light line 67, high voltage power supply board 65, capable of applying 0.0 kV to 15 kV across the electrodes of the array, a CCD camera 64, capillary array cartridge 17, array window holder 19, reservoir 20, drawers 11, drawers 12, fluid lines 68, waste container 26, gel containers 25 and syringe 23. A USB electronic distribution bard is shown as 63.

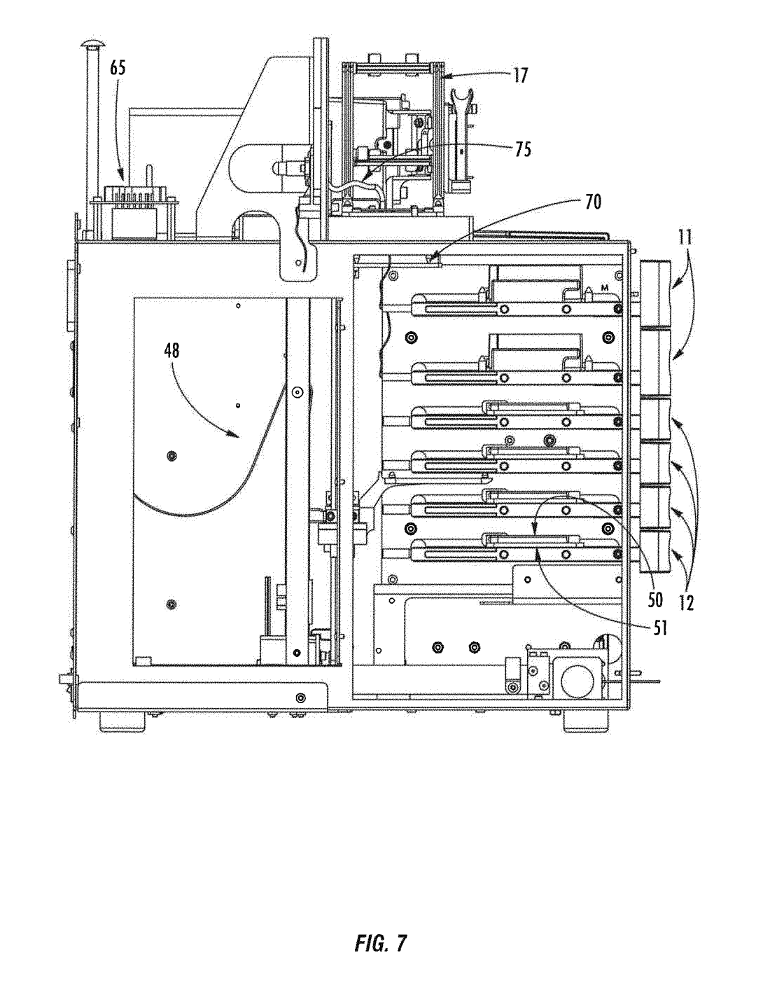

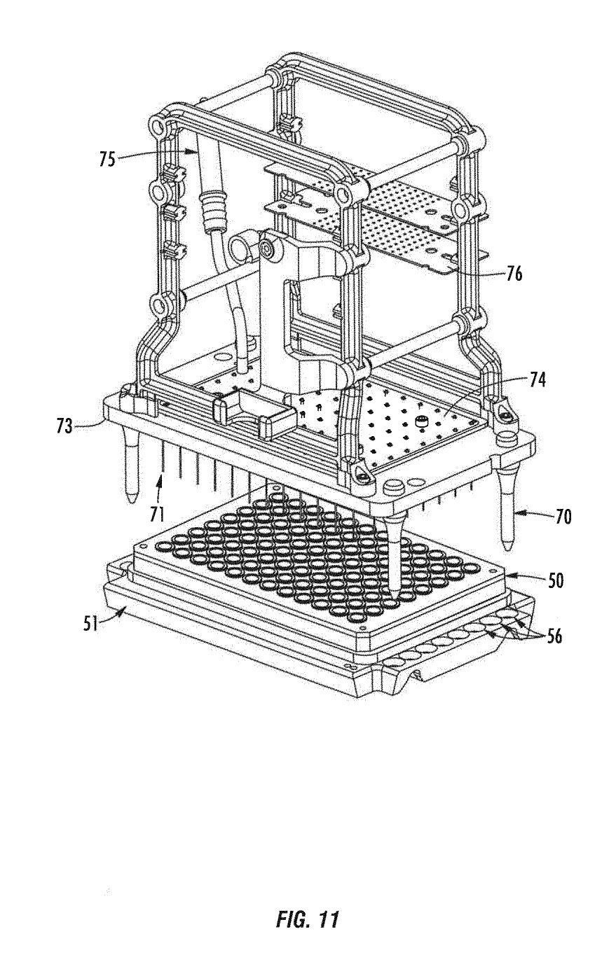

FIG. 7 shows a left side-view of the electrophoresis unit showing the x-z stage assembly 48, which moves tray holders 51 and sample trays 50 from a drawer 12 or 11 to the bottom of array 17. The stage unit 48 can move the sample tray holder 51 and sample tray 50 up in the z-direction to lift the tray holder/sample tray off of the drawer, move back in the x-direction away from the sample drawers, and then move the sample plate up in the z-direction to the bottom of the capillary array 17. After electrokinetic or hydrodynamic injection, the stage unit 48 can move the sample tray holder/sample tray back down to the target drawer position (down in the z-direction), move forward in the x-direction just above the sample plate, and then drop down in the z-direction to set the sample tray holder/sample tray onto the drawer. When the sample tray holder 51 is resting in a drawer, the back edge of the sample tray holder 51 and sample tray 50 are aligned so that they do not lie directly underneath the array 17. This allows the sample stage tray carrier (31, FIG. 3) to move up and down along the entire z-axis with a tray holder/sample tray without colliding into other tray holders/sample trays in the drawers. The alignment pins (70, FIG. 8) on the bottom of array 17 are used to align the tray holder with a tray so that the capillary and electrode tips dip into each sample well of the sample plate and do not collide with other areas of the sample plate. This is shown in more detail in FIG. 11, which shows a sample tray holder 51 with a sample tray 50 aligned underneath a capillary array. Alignment holes 56 on the tray holder 51 force the alignment of the tray holder with the capillary array alignment pins 70.

FIG. 7 also shows high voltage power supply board 65 and high voltage power supply cable (to the array) 75.

FIG. 8 shows an array cartridge 17, with rigid plastic support structure 77, window storage and transport screw 80, capillary support cards 76, high voltage power supply cable 75, and insulating support structure 73 onto which the electric circuit board 74 is placed. Electrodes, 71 protrude through the electric circuit board 74, through the insulating support structure 73, and protrude through the bottom of the array. The electrode material is stainless steel or tungsten. The electrode dimension, which is not a critical aspect of the invention, is 50 mm diametertimes29 mm length. The protrusion from the bottom of the cartridge base is 20.0 mm. The electrodes are soldered onto the circuit board 74. The high voltage power supply cable 75 is also soldered to the same circuit of the electrical circuit board, which enables contact of the electrodes 71 with the high voltage power supply (65, FIG. 6). Capillary tips 72 are threaded through the electric circuit board 74 and insulated support structure 73 and are aligned immediately adjacent and parallel to the electrode tips. The distance between the capillary tips and electrodes are from 0.1 mm to 4 mm. The ends of the capillaries and the ends of the electrode lie in a single plane (i.e. the capillary tips and electrode tips are the substantially the same length, with length variation of no more than about +/−1 mm. Preferably, the length variation of capillary tips and electrode tips is less than 0.5 mm. The capillaries thread through the bottom of the capillary array, through the insulating support structure 73, through the electric circuit board 74, through the capillary support cards 76 (which are supported by the rigid plastic support structure 77) through the capillary window holder 70 with capillary windows 79 centered in the opening of the window holder, and then finally through the capillary reservoir tip 91, in which all capillaries (in this case 12) are threaded through a single hole. For 96 capillary arrays, capillaries are threaded in groups of 12, or preferably groups of 4 in the capillary reservoir tip 79. The capillaries are held in place in the reservoir tip 91 with an adhesive, such as a thermally or uv-curable epoxy.

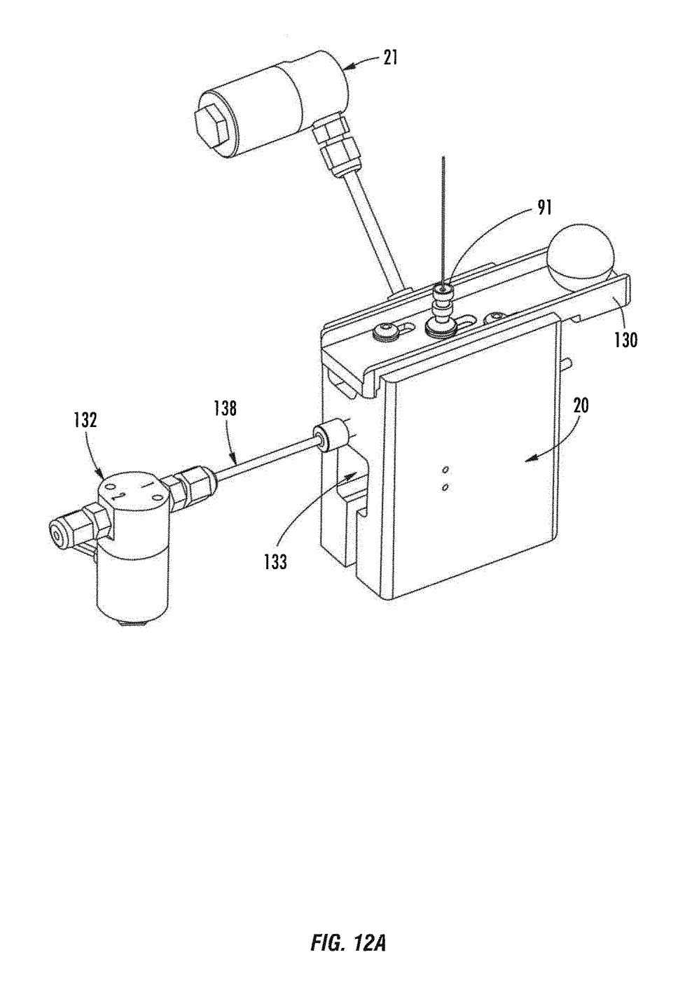

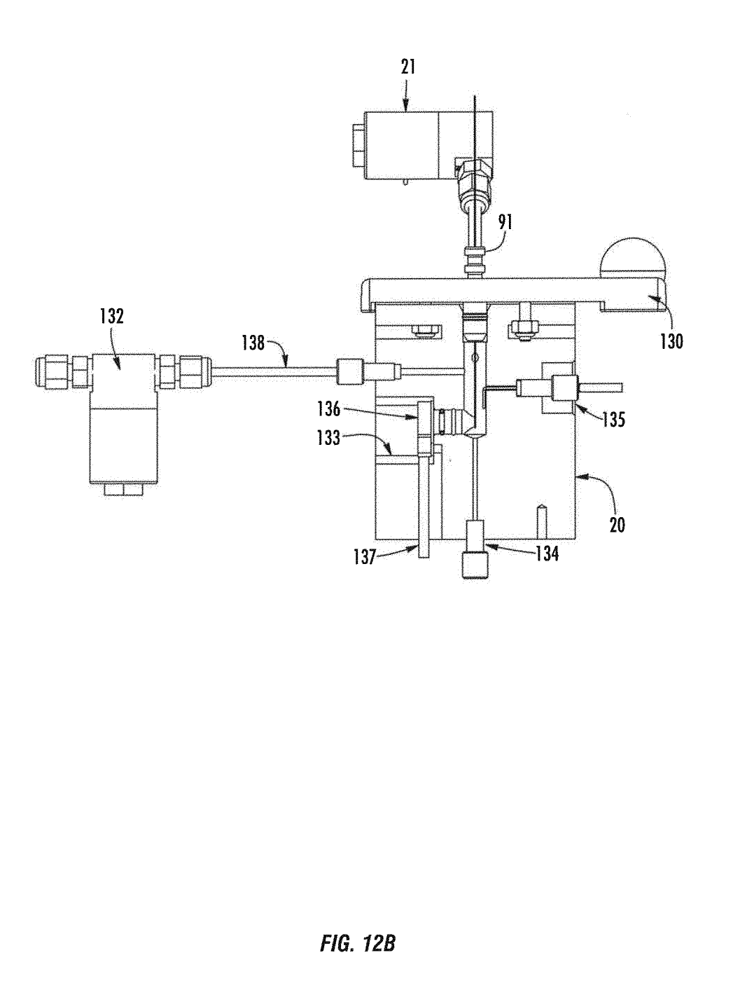

FIG. 12A shows the reservoir, with reservoir body 20, capillary reservoir tip 91, slider bar 130 (for locking capillary reservoir tip into the reservoir, through alignment of a notch on the capillary reservoir tip 91 and the slider bar 130), vent block valve 21, waste tube out 138, waste block valve 132, and pressure transducer cavity 133.

FIG. 12B shows an alternate cut-out view of the reservoir, with reservoir body 20, capillary reservoir tip 91, slider bar 130, vent block valve 21, waste tube out 138, waste block valve 132, electrode for attachment to ground 135, pressure transducer cavity 133, pressure transducer 136, pressure transducer cable for attachment to analog/digital board 137, and fluid tube input 134 (from syringe pump 23 FIG. 2).

The reservoir body can be made of any solid material such as acrylic, Teflon, PETE, aluminum, polyethylene, ABS, or other common metals or plastics. The key criterion is that the material is durable and chemically resistant to the materials used. A preferred material is acrylic or Teflon.

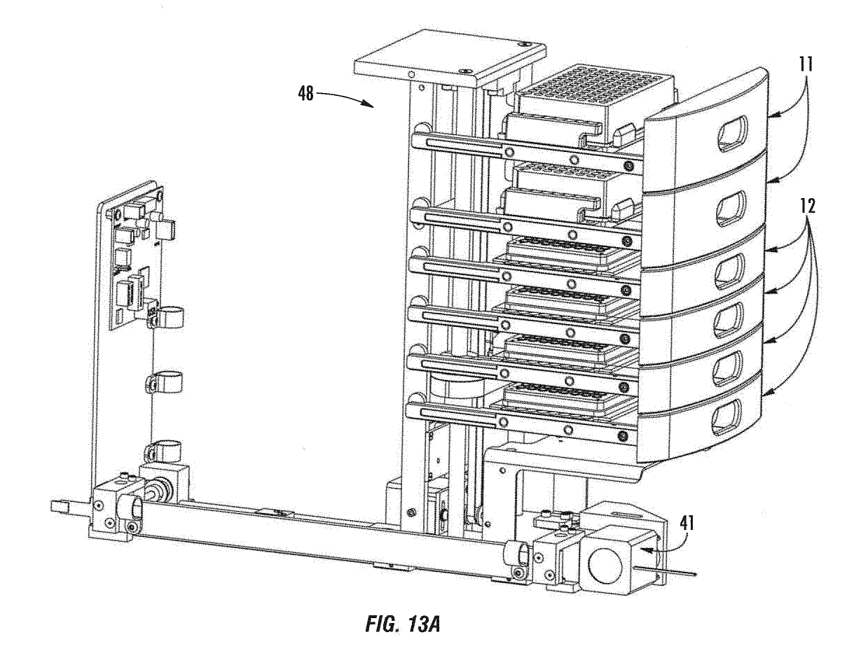

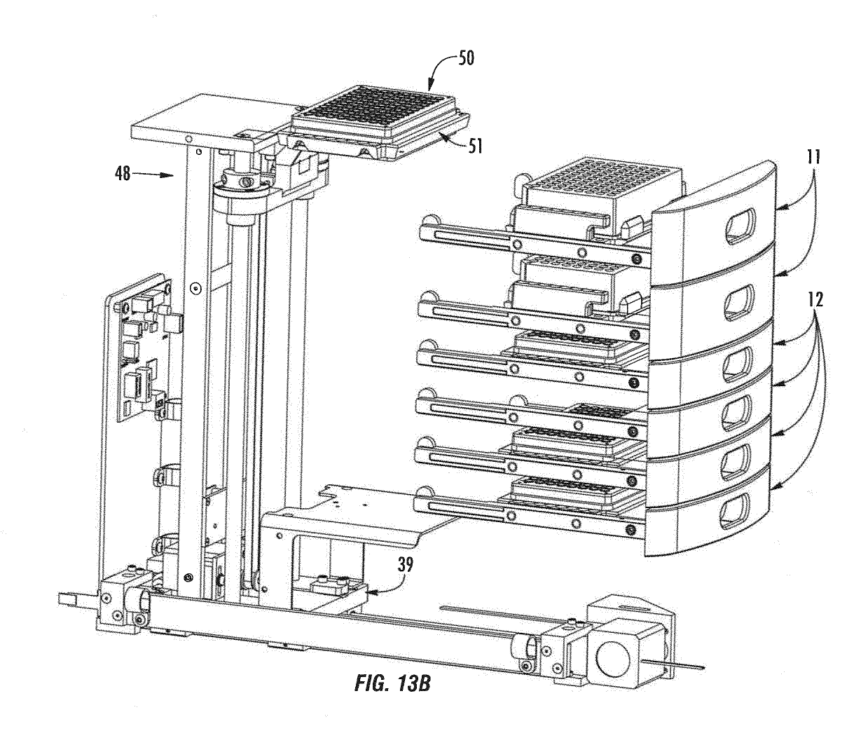

FIG. 13A shows the x-z stage unit 48 in relation to the drawers 11 and 12. The x-z stage is located directly behind the drawers, and can move the stage carrier (39, FIG. 13B) back-and forth in the x-direction using the stepper-motor for the z-position 41. A sample tray is removed from a drawer by first moving the stage forward, towards the drawers, in the x-direction. The tray carrier (31, FIG. 3) lifts a tray holder up and off a drawer in the z-direction using the z-direction stepper motor (41, FIG. 3). The stage carrier is then moved back in the x-direction, away from the drawers, as shown in FIG. 13B. The stage carrier 39 is then moved up in the z-direction to move the tray holder 51 and sample tray 50 to the injection position of the capillary array (FIG. 11).

A typical strategy for pumping fluids for capillary electrophoresis is as follows. Consider the following 6 positions of the six-way distribution valve (29, FIG. 2) on the syringe. Position 1 is connected to the bottom of the reservoir (134, FIG. 12B); position 2 is connected through a tube to a bottle of conditioning fluid (a fluid for conditioning the walls of the capillaries); position 3 is connected to a “Gel 1” which is used for the analysis of genomic DNA, position 4 is connected to a “Gel 2” which is used for the analysis of fragmented DNA, position 5 is unused, or optionally used to clean the vent valve via the pumping of air through the vent valve to the waste bottle and position 6 is connected to the waste bottle.

Step A: The reservoir is first emptied by opening position 1 (reservoir), filling the syringe with fluid that is in the reservoir, closing position 1, opening position 6, and emptying fluid to the waste. This is repeated until the reservoir is empty. Block valves 21 and 132 are kept open during this process to enable efficient draining of the reservoir.

Step B: The reservoir is then filled with conditioning solution by opening position 2, filling the syringe with conditioning solution, closing position 2, opening position 1, and filling the reservoir with conditioning solution. Block valve 21 is closed, but block valve 132 to waste is open, enabling the over-filling of the reservoir with conditioning solution.

Step C: The capillaries are filled by closing both vent block valve 21 and waste vent valve 132. The syringe is filled with capillary conditioning solution. Position 1 is opened, and fluid is pressure filled through the capillaries at a minimum of 100 psi for a pre-determined time, which may range from 1 minute to 20 minutes.

Step D: The reservoir is emptied by step A, and then re-filled with gel using the same process as in Step B, except that position 3 for the gel is used on the 6-way distribution valve.

Step E: The capillaries are filled with gel using a process analogous to Step C.

After steps A-E, the capillaries are ready for electrophoresis.

A general strategy and process for analyzing samples using electrophoresis is as follows.

Samples are placed into a 96-well plate for analysis. The user places the sample plate into a sample drawer (12, FIG. 1), and then adds jobs to a computer-based queue, corresponding to the analysis of a specific row or the entire sample plate in the drawer. The computer, which is the control system of the instrument, executes the analysis of the row or entire tray of interest.

A key embodiment of the invention is the workflow of the capillary electrophoresis system. Drawers (11, FIG. 1) allow easy placement of buffer and waste trays into the system. Drawers (12, FIG. 1) allow easy placement of sample trays into the system. Of particular importance is the ability to place or remove sample trays from drawers (12, FIG. 1) while the system is performing capillary electrophoresis. Indicator lights (120, FIG. 1) show if a tray is present or absent in a drawer, which let users know if a drawer is in place. A typical workflow for a 12-capillary multiplex system is as follows: User A walks up to the machine with sample tray 1, and places it into the third drawer from the top (one of drawers 11, FIG. 1). User “A” then fills a queue with three jobs, which correspond to performing capillary electrophoresis on the three rows of samples: sample tray 1 row A, sample tray 1 row B, and sample tray 1 row C. User “A” then instructs the computer to execute the queue, and as a result, the system begins capillary electrophoresis of sample tray 1, row A, and will continue executing jobs in the queue until there are no more jobs. User “B” then comes up and places sample tray 2 into the fourth drawer from the top (one of drawers 11, FIG. 1). User “B” then adds 8 jobs to the queue corresponding the performing of capillary electrophoresis on 8 rows of samples: sample tray 2, rows A-H. The computer will continue analyzing user “A” samples until they are finished, and then continue on with the analysis of user “B” samples. In the meantime, user “C” walks up and loads sample tray 3 into the fifth drawer from the top (one of drawers 11, FIG. 1). User “C” then adds 1 job to the queue corresponding to the analysis of 1 row of samples: sample tray 3, row A. This process can continue indefinitely, as long as there is sufficient gel in gel containers (25 in FIG. 2), or if there is sufficient run buffer in the buffer tray (28, FIG. 2) located in top drawer 11, FIG. 1. It is, among other things, the enabling of this workflow, via the drawers sample stage, and computer program with a queue for loading jobs that differentiates the present invention from the prior art systems for CE workflow.

An important embodiment of the present invention is a computer program that enables users to load a sample plate into the desired vertical drawer (12, FIG. 1), and instruct the system to run the desired rows or entire sample plate, while the system is running other samples. This allows multiple users to load samples and/or sample plates, or a single user to load multiple samples and/or sample plates without first having to wait for the electrophoresis of other samples to be complete.

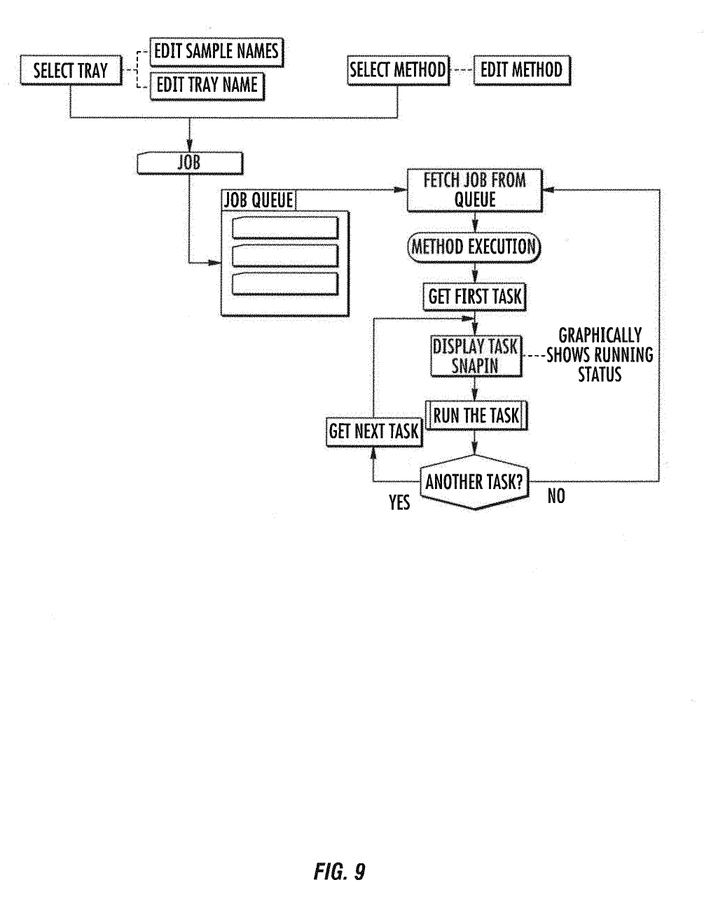

FIG. 9 shows the general flow diagram of the work process and computer program. A user loads a sample tray into a drawer (12, FIG. 1) of the system. On the computer, user then selects the tray, edits sample names and/or tray name. User further selects or defines a method (time of separation, electric field used for separation, gel selection, etc.). This selected tray, along with an associated method is defined as a “job”, which is then placed into a queue. The computer as an instrument control device, fetches jobs from the queue, and controls the instrument for every task, including operation of the syringe pump, operation of the high voltage power supply, and the motion control stage (48, FIG. 3). For each run (or job), there may be a variety of tasks, with each task requiring direct command and control of subunits of the system. Tasks associated with control of the syringe pump include emptying/filling the reservoir with conditioning fluid, forcing conditioning fluid through the capillaries, emptying/filling the reservoir with gel, forcing gel through the capillaries. Tasks associated with control of the x-z stage may include moving or removing a waste tray to/from the inlet capillaries and electrodes of the capillary array, moving or removing a buffer tray to/from the inlet capillaries and electrodes of the capillary array, or moving/removing a sample tray to/from the inlet capillaries and electrodes of the capillary array. Tasks associated with control of the high voltage power supply include turning off/on a high voltage for capillary electrophoresis separation. Other tasks are associated with the camera (acquisition of data), and block valves. For each set of samples, the program will complete all tasks required to obtain a set of electropherograms. Once these tasks are complete, the program fetches another job from the queue. If the queue is empty, all sample runs are complete (until the user initiates another queue).

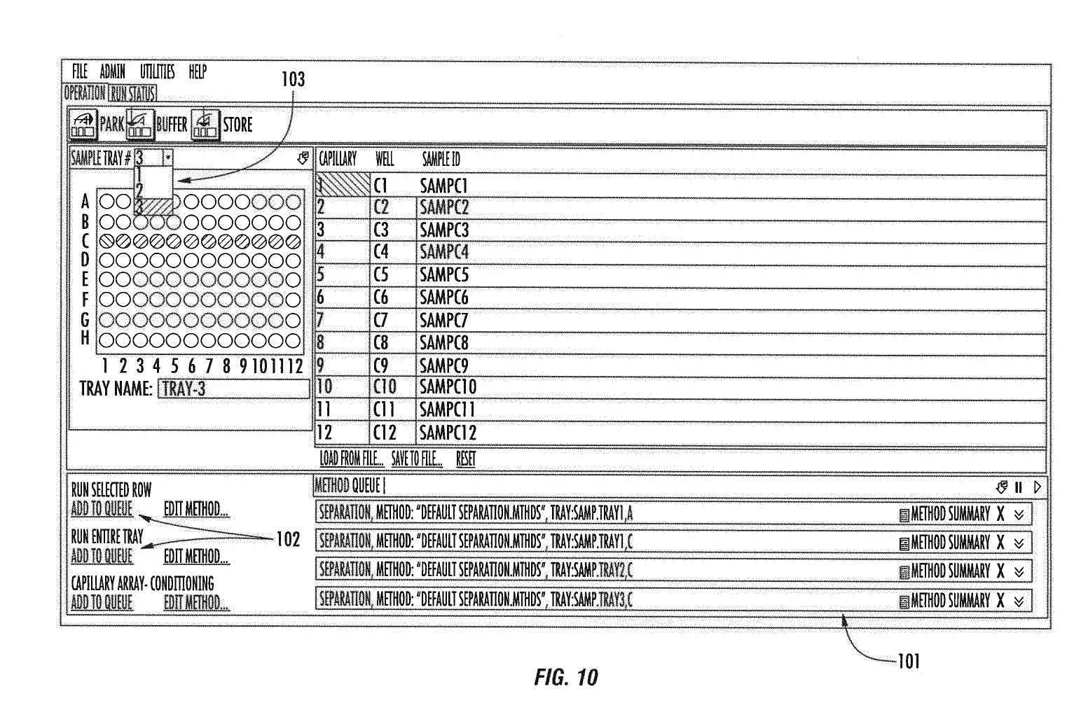

The graphical result of this computer program is shown in FIG. 10, which shows a list of samples to be analyzed in queue 101, an option to add rows or trays to the queue 102, and an option to select the tray number for analysis 103. It is these three aspects that are critical to software portion of the invention: a) Selection of tray 103 (corresponding to a drawer 11 FIG. 1) b) Adding the sample set to a queue (102, FIG. 10) and c) A queue of active samples for analysis (101, FIG. 10), which are executed in sequence until all jobs are complete. Another critical aspect is the ability to add samples to instrument drawers (11, FIG. 1) and queue (101, FIG. 10) while the instrument is running other samples.

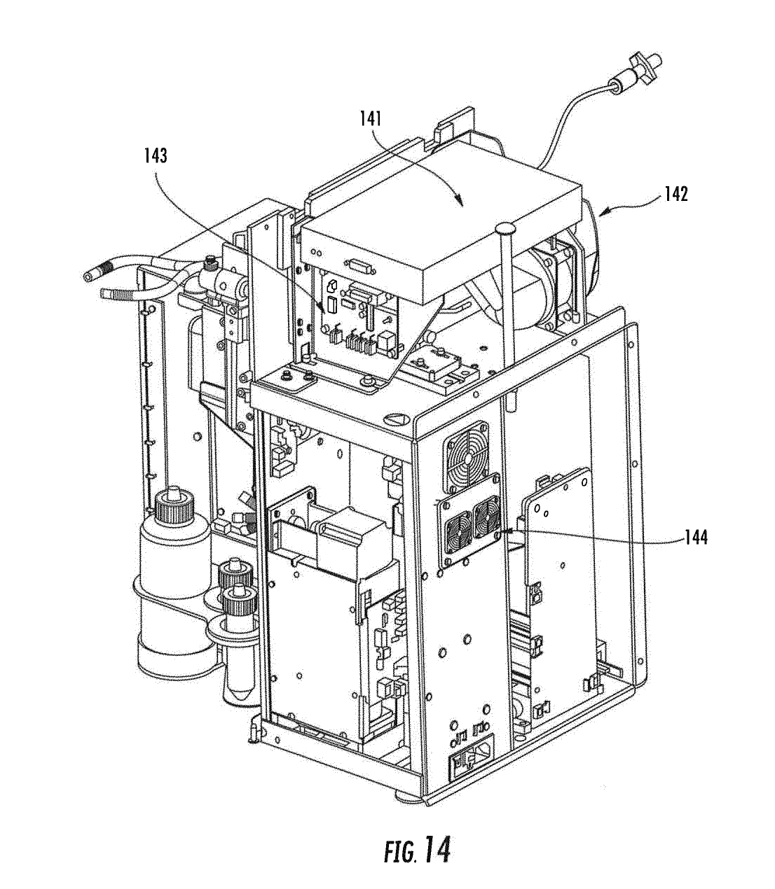

FIG. 14 shows a back view of the instrument with a pulse-field high voltage (HV) power supply 141, control electronics 143, and a cooling fan 142 to remove heat generated by the power supply. Pulsed field voltage power supply 141 with cooling fan 142 replaces constant-field power supply 65 shown in FIG. 6. A preferred pulse-field power supply is a Ultravolt® 20HVA24-BP2, 15HVA24-BP2, or 10HVA24-BP2. The output of the power supply is controlled by a control board 143 with variable control voltage. A non-limiting example is a variable control voltage range between +10V and −10V. The +10 V and −10 V is scaled to the output of the power supply. For a 10 kV power supply, the application of a 10 V control voltage delivers +10 kV from the power supply, whereas the application of a −10V control voltage delivers −10 kV from the power supply. An application of 5 V to this same 10 kV power supply results in an output voltage of 5 kV. For a 20 kV power supply the application of a 10V control voltage delivers a +20 kV from the power supply, whereas an application of 5 V results in 10 kV voltage from the power supply. The control voltage and the associated scaling factor linked with the output of the pulsed-field power supply may be different than the example described above, and is not a critical component of the invention. A waveform generator, which is also a part of control board 143, produces the complex waveforms that result in the variable voltage output of the pulsed-field power supply. For example, a −7V/−4V 10 Hz square wave on the control voltage results in a −7 kV/−4 kV 10 Hz (Pulse Power) output of the HV pulse power supply. The output of the pulsed HV power supply is attached to a multiplex capillary array circuit board 74 through HV power supply cable 75 as shown in FIG. 8. An embodiment of the present invention is the application of a pulse-field power supply to a multiplex capillary electrophoresis system containing at least two and preferably 12 capillaries, so that all capillaries of the multiplex capillary array receive approximately the same pulsed electric field. Another embodiment includes the application of a pulse-field power supply to a capillary electrophoresis system containing at least 24 capillaries. An on-board processor is used to generate waveforms for the control voltage of any desired shape (square, sine, triangle, sawtooth, etc). The frequency of the waveform can vary anywhere from <1 Hz to 5000 Hz. A preferred frequency range is from 1 Hz to 100 Hz. Another preferred range is from 1 Hz to 20 Hz. An especially preferred range is from 2 Hz to 10 Hz. The control board 143 also has voltage and current monitoring circuitry, so that the voltage applied to the capillary electrophoresis system is actively monitored.

For the application to pulse-field multiplex capillary electrophoresis, a waveform is superimposed onto a constant DC voltage. For example, a −5 kV constant voltage relative to ground may be applied to the sample injection or buffer tray side of the capillary array (circuit board 74, FIG. 8), whereas the reservoir side of capillary array is tied to ground (ground wire 130, FIG. 12B). For a 22 cm array (effective length) with a 40 cm total length, this application of −5 kV is equivalent 120 V/cm. For pulse-mode operation, a varying voltage is applied across this example constant offset. For example, a square-wave at a frequency of 5 Hz going from −3 kV to −7 kV (average −5 kV, which is the constant offset) is applied to the sample injection or buffer-tray side of the capillary array (circuit board 74, FIG. 8).

Ramped or varied frequencies are a preferred aspect of the invention. For example, a 60 minute electrophoresis run may have a 3 kV/−7 kV square wave with an initial frequency of 10 Hz at time zero, and a final frequency of 2 Hz at 60 minutes. Variations of the ramp are also a preferred embodiment of the invention. For example a −3 kV/−7 kV square wave may start with 10 Hz at time zero, ramp down to 2 Hz at 10 min, and remain at 2 Hz until 60 min.

Ramped frequencies coupled with complex applied voltage patterns are a preferred aspect of the invention. A non-limiting example is a −3 kV/−7 kV square wave with a frequency of 10 Hz starting at 0 seconds, ramped down in frequency to 2 Hz at 10 minutes. From 10 minutes to 60 minutes of the separation, the frequency of the square wave remains constant at 2 Hz, but the voltage ramps from −3 kV/−7 Kv to −5 kV/−9 kV from the 10 minutes to 60 minutes. The ramp pattern may be linear with time. Alternatively, the ramp may be curved, or stepped with time.

The output of the pulsed-field HV power supply is connected to the inlet electrodes through circuit board 74 (the set of electrodes on the sample or buffer tray side of the capillary array) as shown in FIG. 8, whereas the outlet electrode (electrode on the reservoir side of the capillaries) is connected to ground 135 FIG. 12B.

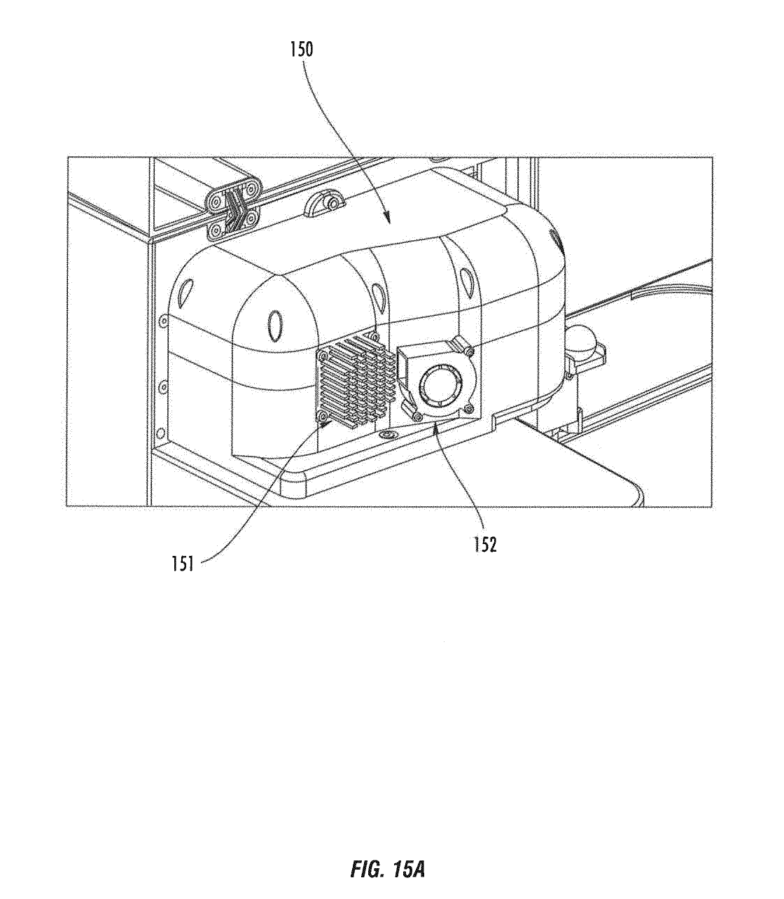

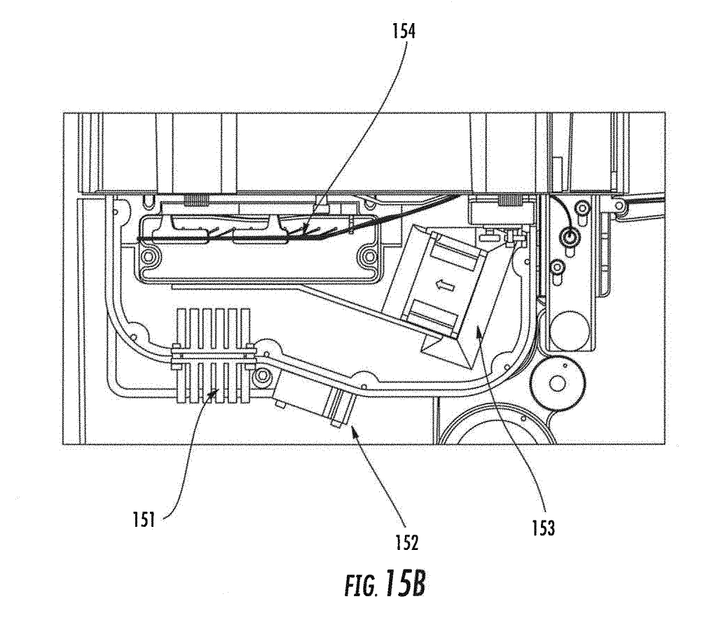

FIG. 15A shows a top view of the instrument with a temperature control chamber 150 with a Peltier cooler 151 and a fan 152 for removing the external heat generated by the Peltier cooler. An example Peltier Cooler of the present invention is CP14, 127-045 (part number 66101-500) made by Lair Technologies.

FIG. 15B shows a top view of the instrument with the temperature control chamber 150 with a cutout view, showing the capillary array 154, and internal heating element and air fan 153, which when combined with Peltier cooler 151 enables precise control of the temperature from 10 C to 25 C.

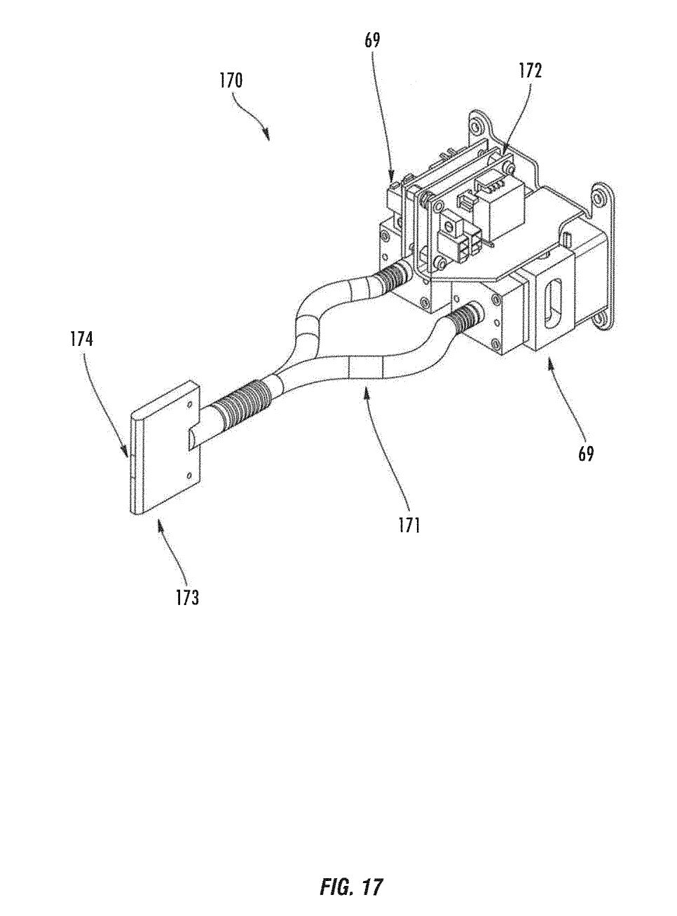

FIG. 17 shows a dual-LED, dual fiber-optic light guide system 170, with two individual LED light engines 69 and two LED control boards 172. A dual-input fiber-optic bundle 171 carries light from each individual LED engine and merges the fibers from the individual input bundles into a single output bundle (wherein the fibers from the input bundle are randomly merged together into the single output bundle, allowing for an even distribution and mixing of light from both LEDs). The output fibers are shaped into a rectangle 174, and held in place by a metal rectangular cube. The fans 144 on the back of the dual LED light-guide system 170 are shown in FIG. 14.

### Example 1

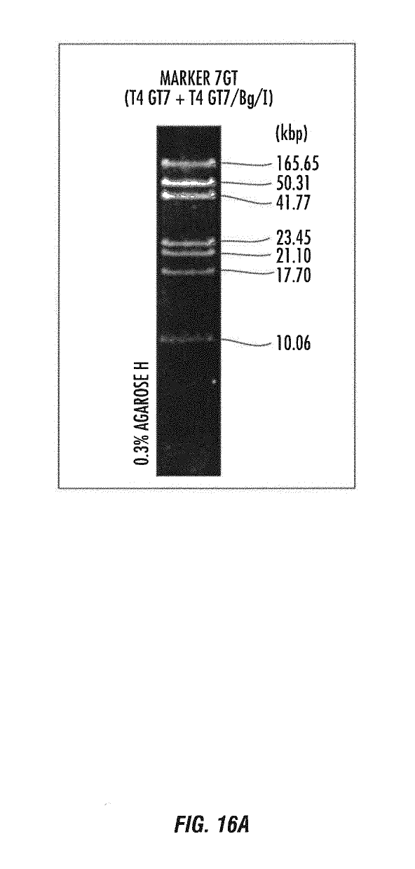

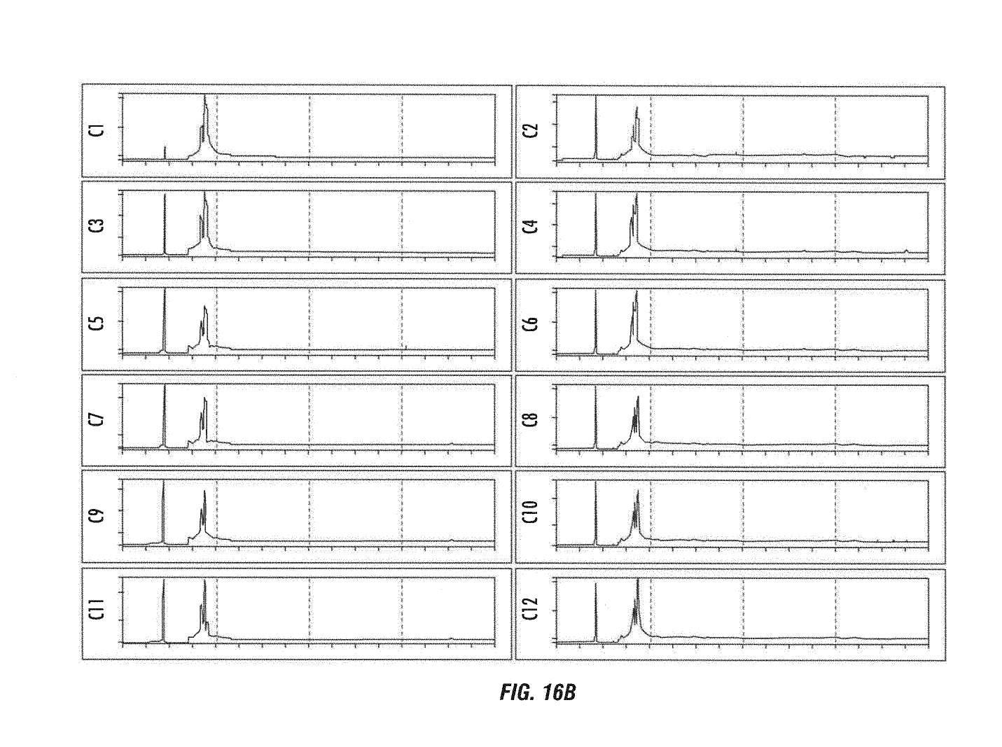

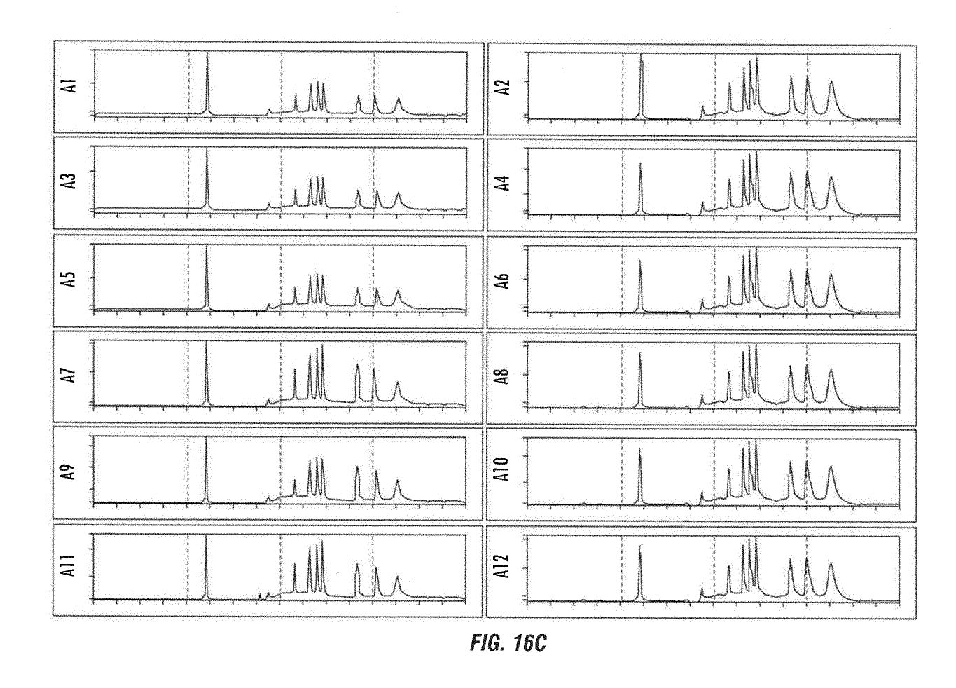

A pulse-field capillary electrophoresis gel “930 Gel” (available from Advanced Analytical Technology) was used for this example. The “930 Gel” sieving matrix was pumped into a plurality twelve capillaries with an effective length of 22 cm and a total length of 40 cm (50 um I.D.) using the capillary electrophoresis system described in this specification. A 7GT DNA sizing ladder (Available from Wako Chemical Company) comprised of DNA fragments with sizes of 10.06 kB, 17.7 kB, 21.2 kB, 23.45 kB, 41.77 kB, 50.31 kB, and 165.65 kB (FIG. 16A) was used to evaluate separation efficiency on a capillary electrophoresis system. A sample of 150 pg/uL of the 7GT ladder in 1× TE Buffer was prepared as a sample for analysis. The gel-filled capillaries were treated with an electrophoresis pre-run by applying 2.0 kV for 1 second prior to injection of sample. The 7GT ladder sample was injected onto the capillary electrophoresis system (present invention) using an electrokinetic injection of 5 kV for 5 sec. This was immediately followed by an electrophoresis run using a constant applied voltage of 7.2 kV for 3600 seconds, with the resulting electropherogram shown in FIG. 16B. This represents a best-case separation for prior-art constant-field capillary electrophoresis systems. The same sample (same injection, same concentration), was then re-analyzed using the capillary electrophoresis system of the present invention, but with pulsed-field applied voltage of −1.8 kV/7.2 kV with a 5 Hz Square Wave. The resulting set of electropherograms for the 12-capillary system is shown in FIG. 16C. The ambient temperature for all analysis (both constant field and pulsed-field) was approximately 23 C. Separation with a Pulsed-field (FIG. 16C) shows a much better baseline resolved electropherogram, with all 7 of the ladder elements clearly visible relative to the separation using prior-art constant-field (FIG. 16B), which shows a single, merged peak. For this example, 12 capillaries were run simultaneously with the same applied constant or pulsed field.

As can be seen from the above description, the pulsed-field multiplex capillary electrophoresis system of the present invention allows for the multiplexed, enhanced separation of fragments with sizes up to >150 kB, compared to prior-art constant-field multiplex capillary electrophoresis systems.

Furthermore, the system eliminates the need for expensive robots, enables the user to run many samples per day, allows loading of new samples while running others, and yet has a small size footprint. The invention as described therefore fulfills the need of providing pulsed-field capillary electrophoresis systems that can run multiple samples simultaneously, and that can measure nucleic acid fragment sizes above about 50,000 bp, and preferably above 150,000 bp.

What is claimed is:

1. An Electrophoresis console for multiplex pulse-field electrophoresis that will measure larger base-pair DNA fragments, comprising:
a console housing an operable multiplexed capillary electrophoresis system with a multiplex adjacent and parallel capillary array; and
a pulse-field alternating current power supply for applying a pulsed electric field for electrophoresis on all adjacent and parallel capillaries of said multiplex parallel capillary array simultaneously; and
at least two drawers in said console containing separately at least a buffer plate and sample plate; and
a motion control system built within said console to move said sample plates and/or buffer plates or both from said drawers to an injection position of said multiplexed capillary electrophoresis console.

2. The electrophoresis console of claim 1 wherein the drawers include at least four vertically stacked drawers.

3. The electrophoresis console of claim 1 wherein the drawers include at least six vertically stacked drawers.

4. The electrophoresis console of claim 1 arranged so samples can be placed into said drawers while the instrument is running and collecting electrophoresis data, and wherein said motion control system can access any selected drawer, in any order, for injection of a subsequent electrophoresis run.

5. The electrophoresis console of claim 1, which includes in it an operative computer program that enables multiple users to load multiple sample plates into said drawers, wherein said multiple sample plates can be selected in any order for subsequent electrophoresis runs.
